(19) United States
(12) Patent Application Publication
(10) Pub. No.: US 2005/0176473 A1
(43) Pub. Date: Aug. 11, 2005

(54) Internet protocol based wireless communication arrangements

(76) Inventor: Diego Melpignano, Monza (IT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/503,047

(22) PCT Filed: Jan. 24, 2003
(86) PCT No.: PCT/IB03/00194

(30) Foreign Application Priority Data
Jan. 29, 2002 (EP) 02076237.3
Jul. 11, 2002 (EP) 0207786.8

(51) Int. Cl. H04B 1/38; G06F 15/16

(52) U.S. Cl. 455/574; 709/230

(57) ABSTRACT

Mobile devices such as Personal Digital Assistants or mobile phones can connect to the Internet or another IP based network using WPAN and WLAN infrastructures or cellular systems like GPRS or 3G. Multi-mode hardware such as combination chipsets that support these standards are becoming available as well. According to the present invention, wireless network driver software architecture is proposed, named Multi-standard Wireless Adaptation Layer (MWAL) and is for client devices MT that may be portable, need to efficiently switch from one wireless standard to another and that must be able to stay connected and reachable in the Internet or other IP based network even when switching between wireless communication standards. The technique of the invention is a layer 2 technique suitable for vertical markets and proprietary solutions, in which the MWAL enables the client device MT to perform vertical handovers between wireless communications standards.

The present invention relates to Internet Protocol (IP) based wireless communication arrangements and in particular, but not exclusively, to an Internet Protocol based wireless communication arrangement in which an Internet Protocol based network can be accessed including substantially seamless vertical handovers made between a plurality of communications standards without losing a current connection.

Wireless connectivity to the Internet, or another IP-based network, can be achieved by client devices such as Personal Digital Assistants (PDAs), laptops and mobile phones using different access networks. Some such networks comprise Wireless Local Area Networks (WLAN), Wireless Personal Area Networks (WPAN) or cellular systems like Generalized Packet Radio System (GPRS) and so-called third generation mobile telecommunications (3G).

Some devices already have the capability of using more than one wireless communications standard or access network to gain access to the Internet or other Internet Protocol based network. One example is a GPRS phone with Bluetooth support: when used inside a building, Bluetooth network access points can forward traffic between the mobile phone and the Internet, while the GPRS standard offers the same functionality outdoors at a lower speed. This trend is predicted to continue, as more wireless standards are likely to become available that offer diversified characteristics and costs. The Internet or other IP-based networks will thus be accessed by a variety of wireless devices that need to be connected and reachable.

The Internet Engineering Task Force (IETF) is developing protocols for mobility of Internet hosts, as discussed in:
(1) IETF Mobile IP WG, http://www.ietforg/html.charters/mobileip-charter.html
(2) K. El Malki et al., “Low Latency Handoffs in Mobile IPv4”, http://www.ietf.org/internet-drafts/draft-ietf-mobileip-lowlatency-handoffs-v4-03.txt (work in progress),
(3) G. Dommeti et al., “Fast Handovers for Mobile IPv6”, http://www.ietf org/internet-drafts/draft-ietf-mobileip-fast-mipv6-03.txt (work in progress).

These proposals are not finalized yet. Furthermore, the above protocols (Mobile IP and its derivatives) will have to rely on lower layer capabilities, which have not been standardized either by the priority date of this application.

A proposal towards a platform-independent IP transmission arrangement including framework and information may be found for example in:
(4) P. Mahonen et al. “Platform-Independent IP Transmission over Wireless Networks: The WE Approach”, IEEE PCM, December 2001. Here the focus is on boosting IP transport in homogeneous wireless networks.

One attempt to introduce a unified wireless network interface is being made within the Mobile Wireless Internet Forum (MWIF):
(5) http://www.mwiforg. This approach, however, is mainly for cellular systems only, so WLANs and WPANs are not considered there.

A generic interface for handling wireless interfaces has been introduced in the Linux operating system and information may be found for example in:
(7) J. Tourrilles, “Wireless Extensions”, but that only supports one interface at a time and it is specific to the Linux operating system for such functionality as asynchronous event generation. It can be found at:
   http://www.hpl.hp.com/personal/Jean_Tourrilhes/Linux/Tools.html.

The above arrangements highlight the need for an efficient solution to enable mobile devices to change between wireless access technologies without losing a current connection and preferably in dependence on the sensed wireless network infrastructure. The known solutions fall short of providing a suitable solution to this problem.

It is an object of the present invention to provide improved Internet Protocol based wireless communication arrangements and in particular, but not exclusively, to provide an Internet Protocol based wireless communication arrangement in which an Internet Protocol based network can be accessed including substantially seamless vertical handovers made between a plurality of communications standards and preferably without losing a current connection.

Accordingly, the present invention provides a client device for an Internet Protocol (IP) compatible communications arrangement, said client device including multi-standard hardware adapted to support wireless operation of said client device in accordance with a plurality of Internet Protocol compatible wireless communications standards, operation of said multi-standard hardware being controlled by a network driver that includes a software architecture having a wireless adaptation layer arranged in use to enable said client device to perform vertical handovers between said wireless communications standards.

A client device according to claim 1, wherein said vertical handovers are seamless.

Said wireless adaptation layer may be adapted to allow network based applications to be run transparently on said client device during said vertical handovers.

Said client device may determine which wireless access networks are available and said vertical handovers may be performed in dependence on the infrastructure of the or each said available wireless access network.

Said device comprises a user portable terminal, such as for example a Personal Digital Assistant (PDA), a lap-top computer, a mobile communications device or similar/functional equivalent. The client device may be mobile such that it comprises a mobile terminal roaming between areas of coverage of a plurality of wireless networks or may be stationary temporarily or substantially permanently. A said Internet Protocol compatible wireless communications standard may comprise any suitable wireless access system, e.g. Frequency Division Multiple Access (FDMA), Code Division Multiple Access (CDMA), Time Division Multiple Access (TDMA), Time Division Duplex (TDD), Orthogonal Frequency Multiple Access (OFDMA) or combinations of these such as CDMA/FDMA, CDMA/FDMA/TDMA, FDMA/TDMA. As a specific example, one of IEEE 802.11b, Bluetooth and the Generalized Packet Radio System (GPRS) may be selected.

The present invention also provides a software product suitable for implementing a wireless adaptation layer of a network driver in a client device according to the invention, said software product including code for providing a uniform interface to an Internet Protocol layer of a protocol stack of said client device for at least one of:
a) transmitting Internet Protocol packets;
b) monitoring radio link quality,
c) controlling radio link quality;
d) paging further devices; and
e) handing over said client device between different access points or base stations of a network or between networks.

Said wireless adaptation layer interface may provide to an operating system of said client device and to applications a single interface between Layer 2 and Layer 3 of an OSI protocol stack, through which interface one or more of data, commands and events may be exchanged.

The software product may include a wireless adaptation layer coordinator for controlling the overall operation of said wireless adaptation layer interface and having code for at least one of:
a) determining and controlling the loading and unloading of software modules;
b) code for arranging a said vertical handover; and
c) code for receiving commands from applications and sending back events.

Said wireless adaptation layer interface may provide separate access to a data plane and to a control plane of said network driver, so as to enable a control application of said wireless adaptation layer to manage a connection through one said wireless communications standard while another said wireless communications standard is used to exchange data.

Said wireless adaptation layer interface may appear to an operating system of said client device as a shared resources network interface, e.g. a Token Ring or Ethernet LAN interface that is controllable by means of a socket interface from an application layer.

Software modules may be dynamically loaded and unloaded into and out of the wireless adaptation layer, a said module including code for interfacing said wireless hardware to a said wireless communications standard or to operate on Internet Protocol packets that are forwarded by the wireless adaptation layer.

Said software product may include a lower layer driver module having code for encapsulating features specific to a particular said wireless communications standard for transmitting and/or receiving Internet Protocol packets on a wireless link between said client device and a further client device or a network.

A said lower layer module may include code for at least one of the following:
a) initialization of the lower layers of a baseband processor;
b) exchanging data frames and/or control messages with said multi-standard hardware module;
c) managing the establishment of connections;
d) managing a paging channel such that said client device is waken from an idle mode;
e) managing a low power mode of said client device;
f) monitoring the quality of link in a wireless connection of said client device.

A said lower layer module may comprise a data plane and a control plane, a said data plane including code for forwarding frames between said wireless adaptation layer and said hardware module and a said control plane including code for at least one of discovering if a network access infrastructure is present and establishing connections before exchanging data.

Said software product may include a software module having code for monitoring the flow of Transport Control and/or Internet Protocols (TCP/IP) segments in both upstream and downstream directions, said module preferably including code for freezing a Transport Control Protocol (TCP) sender if a wireless link becomes unusable, further preferably freezing said sender at least until a new link becomes available.

Said software product may include a software module having code for ensuring that a Medium Access Control (MAC) address of said wireless adaptation layer does not change during a said vertical handover.

Said software product may include a software module having code for monitoring quality of service and, if multiple wireless connections are in place involving said client device, preferably also having code for prioritizing traffic according to the requirements of a currently running application.

The present invention also provides a method of supporting wireless operation of a client device, the method including configuring multi-standard hardware of said client device to perform vertical handovers of said client device under the control of a wireless adaptation layer of a network driver between a plurality of Internet Protocol compatible wireless communications standards.

The present invention also provides an Internet Protocol compatible communications system adapted to provide a connection with a client device through one of a plurality of wireless communications standards, a said client device preferably comprising a mobile terminal and including multi-standard hardware adapted to support wireless operation of said client device in accordance with a plurality of said wireless communications standards, operation in or changes between said standards being controlled by a predetermined software architecture that includes a wireless adaptation layer (WAL) arranged in use to enable said client device to perform vertical handovers between said wireless communications standards.

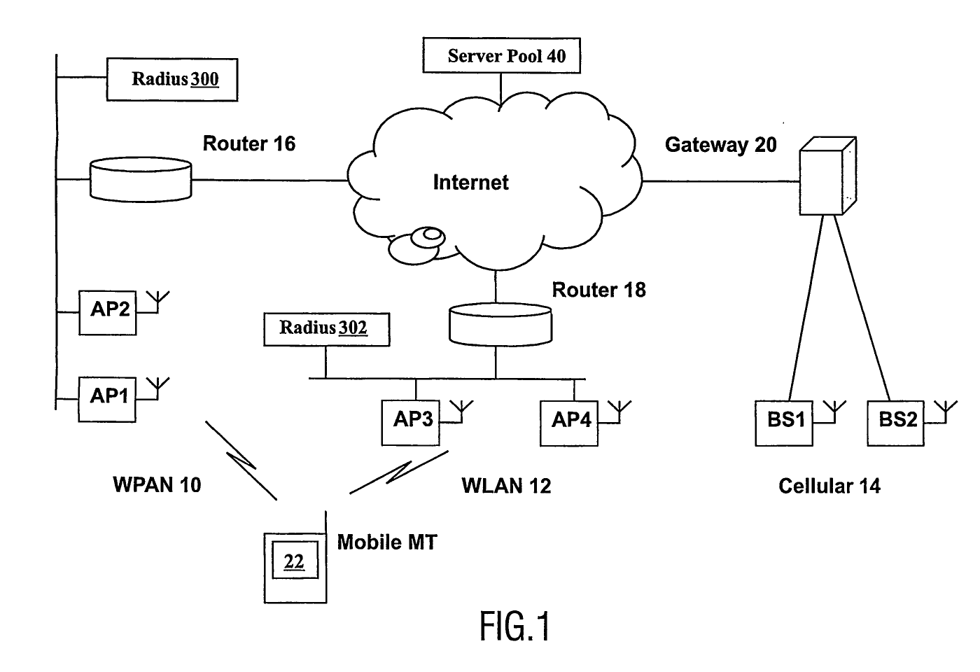

FIG. 1 is a reference architecture for a communications system including an arrangement according to an embodiment of the present invention;

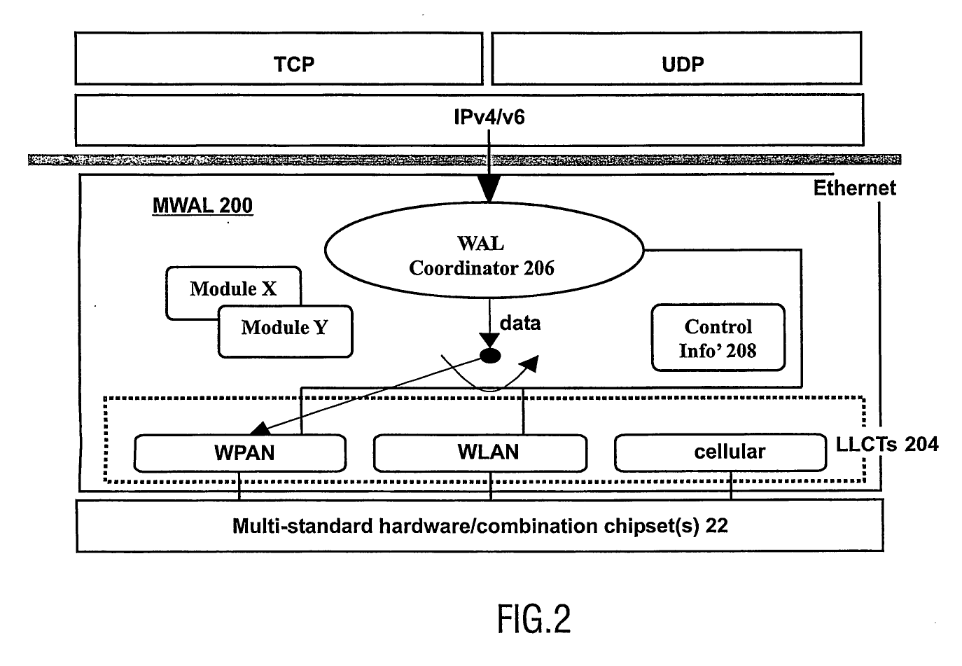

FIG. 2 is a schematic diagram of the architecture of a network driver of the system of FIG. 1;

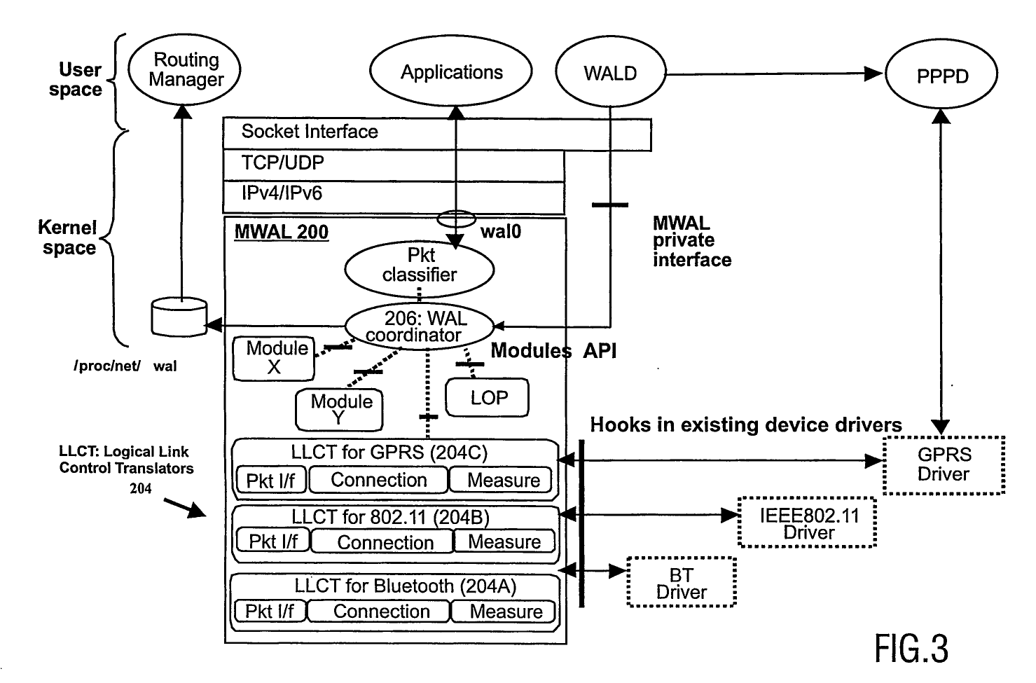

FIG. 3 is a more detailed diagram of software components of the architecture depicted in FIG. 2;

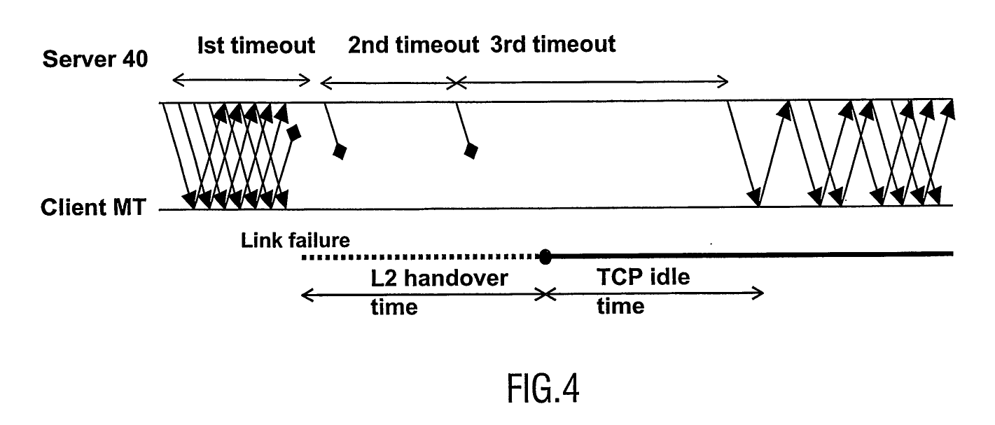

FIG. 4 is a schematic diagram of the effects of link disconnection on Transport Control Protocol (TCP);

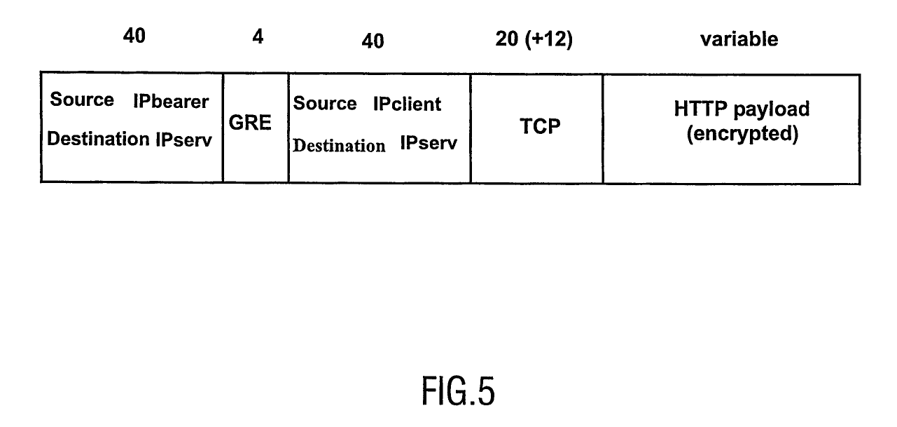

FIG. 5 is a block diagram of an IP-to-IP tunnel configuration used in the arrangement according to FIG. 1;

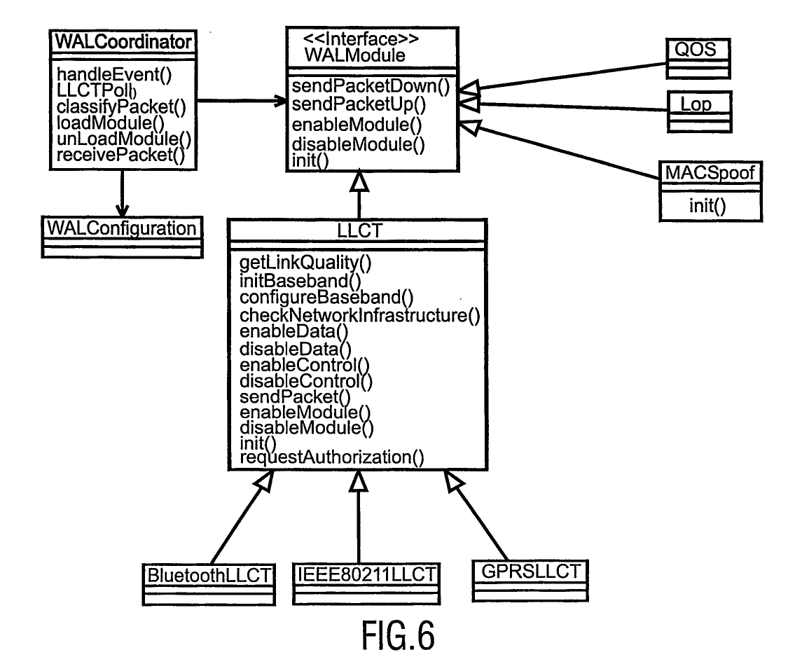

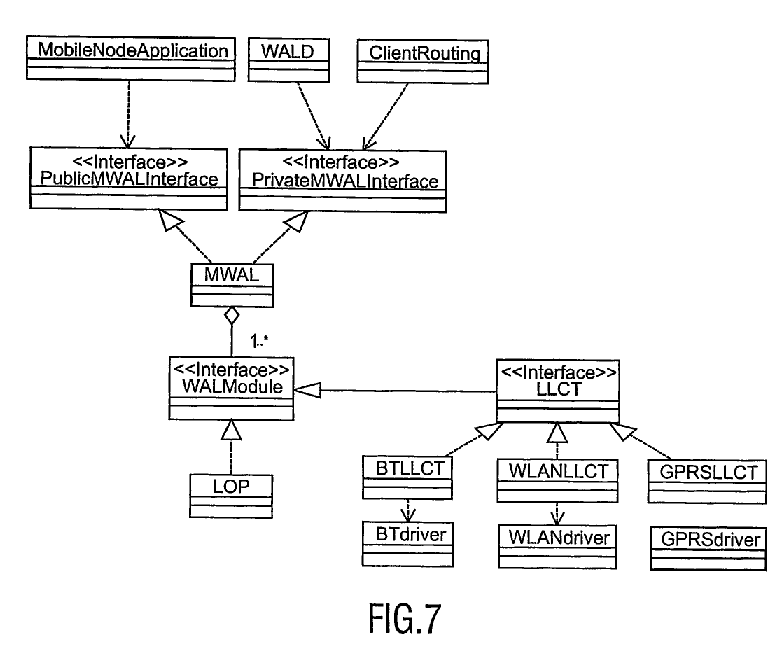

FIGS. 6 and 7 are class diagrams for the architecture and associated software of FIGS. 2 and 3;

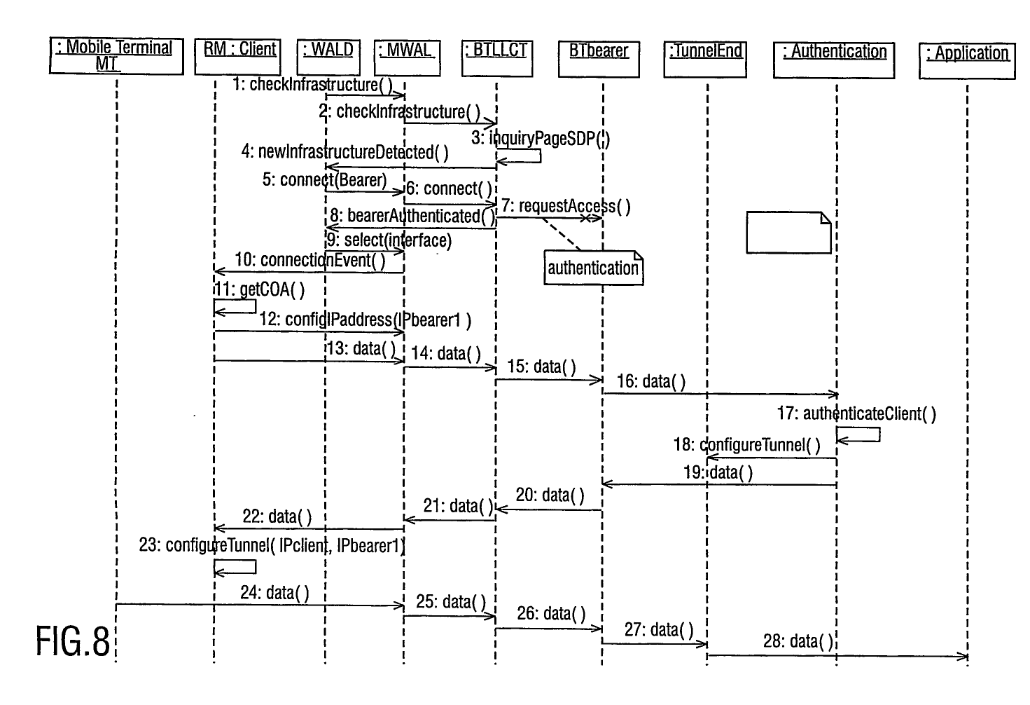

FIG. 8 is a sequence diagram of initial access to a server using the arrangement of FIGS. 1 to 3;

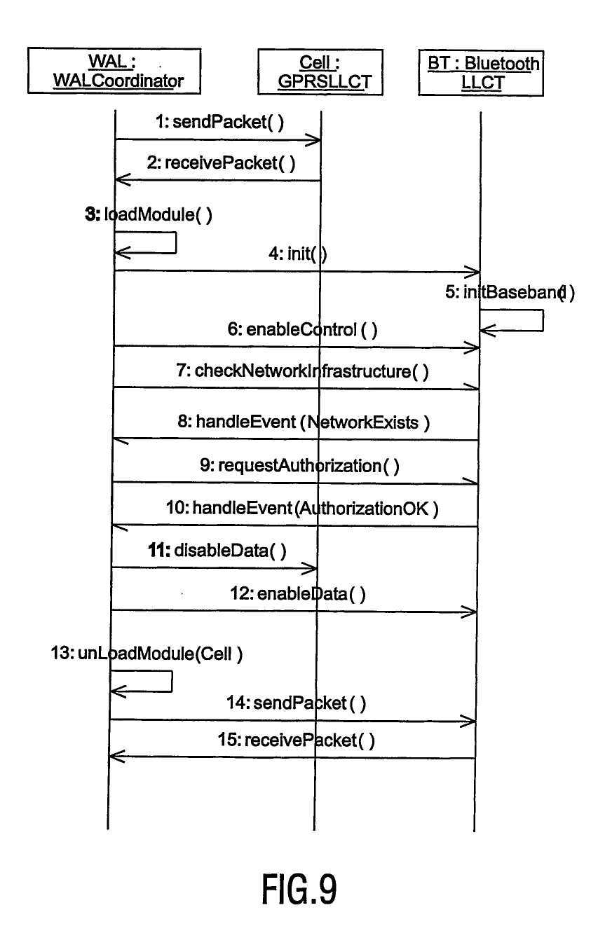

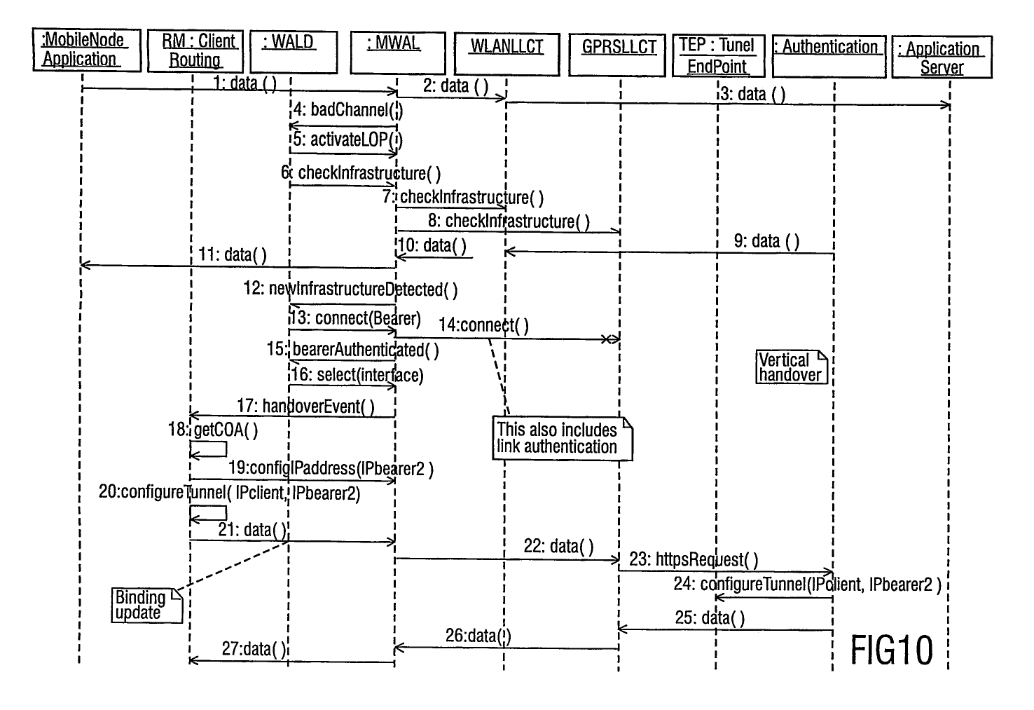

FIGS. 9 and 10 are sequence diagrams of vertical handover between different wireless communications standards using the arrangement of FIGS. 1 to 3;

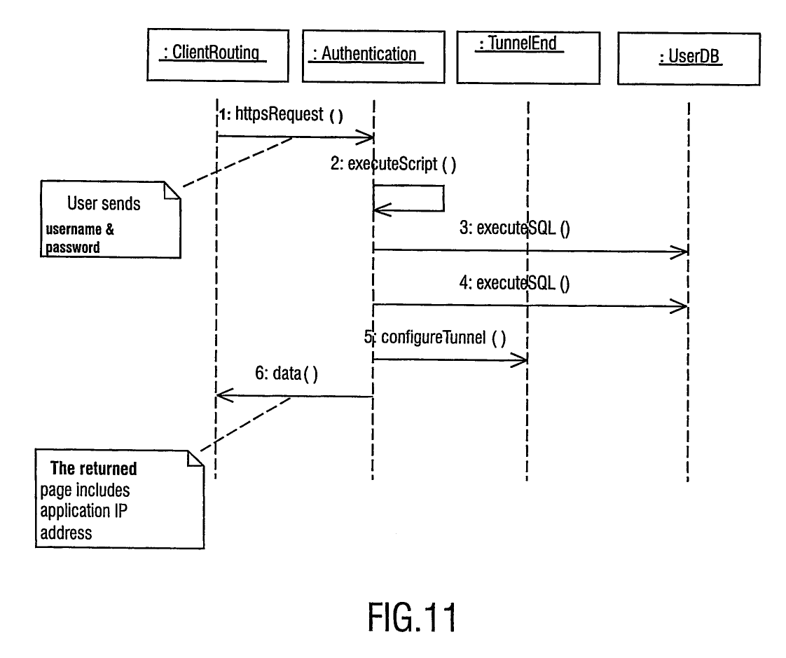

FIG. 11 is a sequence diagram of a client authentication procedure used in the arrangement of FIGS. 1 to 3; and

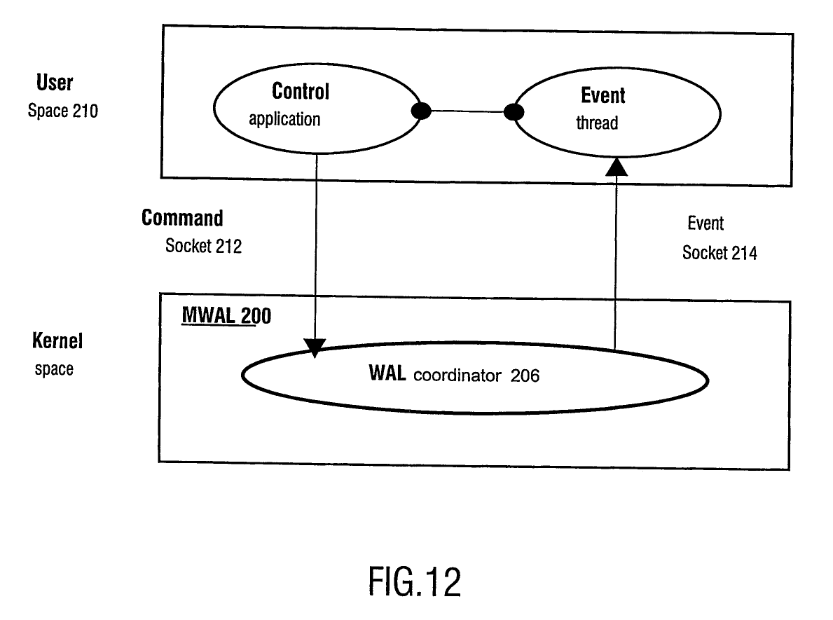

FIG. 12 is a block diagram of a network interface of the arrangement of FIGS. 1 to 3.

The present invention will now be described with reference to certain embodiments and with reference to the above mentioned Figures. Such description is by way of example only and the present invention is not limited thereto. The term “comprising”, e.g. in the claims, does not exclude other elements or steps and the indefinite article “a” or “an” before a noun does not exclude a plurality of the noun unless specifically stated. With respect to several individual items, e.g. a channel decoder, channel equalizer, or items given an individual function, e.g. a channel decoding means, channel equalizing means, the invention includes within its scope that a plurality of such items may be implemented in a single item, e.g. in a processor with relevant software application programs to carry out the function.

In the present invention reference is made to a client device arranged in use to connect to a network in accordance with one of a plurality of communications standards. The term “plurality of communications standards” when referred to a client device means to a skilled person a multi-mode terminal. Such a multi-mode terminal could be a PDA with a so-called combination chipset or “combo” card, i.e. a card that provides the functionality to the device of Bluetooth, IEEE802.11b and GSM/GPRS transceivers. A “standard used in communications arrangements may comprise a technical guideline advocated by a recognized organization, which may comprise for example a governmental authority or noncommercial organization such as the ETF, ETSI, ITU or IEEE, although not limited thereto. Standards issued or recommended by such bodies may be the result of a formal process, based for example on specifications drafted by a cooperative group or committee after often intensive study of existing methods, approaches and technological trends and developments. A proposed standard may later be ratified or approved by a recognized organization and adopted over time by consensus as products based on the standard become increasingly prevalent in the market. Such less formal setting of a “standard” may further encompass technical guidelines resulting from implementation of a product or philosophy developed by a single company or group of companies. This may particularly be the case if, through success or imitation, such guidelines become so widely used that deviation from the norm causes compatibility problems or limits marketability. The extent to which a piece of hardware conforms to an accepted standard may be considered in terms of the extent to which the hardware operates in all respects like the standard on which it is based or designed against. In reference to software, compatibility may be considered as the harmony achieved on a task-orientated level among computer elements and programs. Software compatibility to a standard may therefore also be considered the extent to which programs can work together and share data.

The present invention provides an efficient arrangement to enable mobile devices to change between wireless access standards substantially seamlessly and without losing a current connection, preferably making such changes in dependence on the sensed infrastructure of one or more available wireless networks. Any suitable wireless access system may be used, e.g. Frequency Division Multiple Access (FDMA), Code Division Multiple Access (CDMA), Time Division Multiple Access (TDMA), Time Division Duplex (TDD), Orthogonal Frequency Multiple Access (OFDMA) or combinations of these such as CDMA/FDMA, CDMA/FDMA/TDMA, FDMA/TDMA. General information on wireless protocols may be found in “OFDM for wireless multimedia communications”, by Richard van Nee and Ramjee Prasad, Artech House, 2000; Wideband CDMA for third generation mobile communications”, by Tero Ojanpera and Ramjee Prasad, Artech House, 1998, “Personal Wireless Communication with DECT and PWT”, by John Phillips and Gerard Mac Namee, Artech House, 1998, CDMA for wireless personal communications”, by Ramjee Prasad, Artech House, 1996; Cordless telecommunications Worldwide”, by Walter Tuttlebeee, Springer, 1997 and similar standard texts.

In the user's terminal (client device/mobile terminal), the criteria to select one wireless access technology instead of another may vary depending on usage scenarios. The user can, for example, set his preference using a dedicated configuration tool in the mobile terminal. In each embodiment, a client device is equipped with multi-standard wireless hardware, sometimes referred to as a combination or “combo” chipset, that supports multiple wireless communication standards and that can be controlled by a single software network interface. This software driver may be called a Wireless Adaptation Layer (WAL) and provides a uniform interface to the Internet Protocol (IP) layer for such functions as:
1. transmission of IP packets;
2. radio link monitoring and control;
3. paging of idle devices (e.g. client/mobile); and
4. handover between two access points AP (or base stations BS) possibly using heterogeneous standards.

WAL is a wireless network driver that is designed to allow native Internet applications to be run transparently on client/mobile devices, e.g. without the need to change common transport protocols like TCP/IP or UDP/IP. A suitable set of basic design principles for WAL are described in: P. Mahonen et al. “Platform-Independent 1P Transmission over Wireless Networks: The WINE Approach”, IEEE PCM, December 2001, where the focus is on boosting IP transport in homogeneous wireless networks.

Referring to the Figures and for the moment in particular to FIG. 1, a reference architecture is depicted schematically in which a client device is user portable and therefore may be considered as embodied in the form of a mobile terminal MT. The client device/mobile terminal MT may be embodied for example as a personal digital assistant (PDA), a mobile telephone or a lap-top computer and, while roaming, stays connected to a current IP based service whichever of its available wireless access technologies is being used.

This mobile terminal MT wants to connect to the Internet (or other IP based network as the case may be) while moving among areas each of which is covered by one or more access networks, e.g. a wireless personal area network (WPAN) 10, a wireless local area network (WLAN) 12 and a cellular network 14. In the non-limiting embodiment illustrated, connection to the Internet is made through at least one of: WPAN access points AP1, AP2 and a WPAN router 16; WLAN access points AP3, AP4 and a WLAN router 18; or through base stations BS1, BS2 of the cellular network 14 and an associated gateway 20.

The mobile terminal MT preferably includes integrated multi-standard wireless hardware 22 adapted to support operation of the mobile terminal MT under any of a plurality of wireless communications standards at their respective link layers, as available and supported for the time being by appropriate access networks. These wireless communications standards may comprise, for example, Bluetooth (BT), IEEE 802.11 and Generalized Packet Radio System (GPRS) for respectively the WPAN 10, WLAN 12 and cellular 14 access networks.

A server or server pool 40 can be reached using Wireless LAN infrastructure (IEEE 802.11b, AP3,4) or Bluetooth access points (AP1,2) while in the corporate office, or using cellular access (BS1,2) like GPRS while on the move. A useful discussion of Bluetooth™ communications can be found in text book form in “Bluetooth™, Connect Without Wires” by Jennifer Bray and Charles F. Sturman, published by Prentice Hall PTR under ISBN 0-13-089840-6. IEEE 802.11b is more suitable when wider access is needed in office or building neighborhoods and higher bandwidth is desirable. General information on wireless LAN protocols and systems may be found in “Wireless LANs”, by Jim Geier, Macmillan Technical press, 1999. When wireless LAN resources are not available, (e.g. neither Bluetooth™ nor IEEE 802.111b), then GPRS connectivity can be used.

A preferred embodiment of a mobile terminal MT may comprise a Personal Digital Assistant (PDA), based for example on a Compaq iPAQ platform. In that case, Bluetooth access may be preferable to WLAN because of power consumption issues, while GPRS can always be an available backbone where no other access points AP1-4 provide radio coverage.

The network that connects the access points AP1-4 in the corporate scenario may include several IP subnets connected together by routers (optionally by a VPN on the public Internet). Once the mobile terminal MT has an ongoing session with a server 40 in the Internet, the session is preferably not interrupted when the mobile terminal MT switches from one access system (BT, IEEE 802.11, GPRS) to another. Existing TCP/IP sessions should be prevented from stalling (i.e. stopping such that an application must be restarted or user intervention is needed to resume).

Compared to a more general scenario of Mobile IP, where all roaming terminals keep their home address and can be reached from anywhere in the Internet, an arrangement according to the present invention may also support a simpler scenario. In such a simplified scenario, mobility may be supported for only a limited set of mobile terminals MT that want to connect to a particular server in the pool 40 on the Internet, where critical data is made available or a service can be accessed usually through a Web interface.

In order to perform a vertical handover between wireless standards in the mobile terminal MT, there must be coordination of functions, e.g. belonging to a data link layer (managing multiple wireless interfaces) and belonging to a network layer (making sure that the mobile terminal MT gets a new routable IP address if appropriate and that packets are routed to the new IP address). The solution involves both link and network layers in the mobile terminal MT, while at the server side 40 a front end may need to be developed to manage client IP mobility. Mobile Ipv4 is considered to have security limitations, to be complex and to be of limited life once MIPv6 is employed.

When the vertical handover is performed the mobile terminal MT will most likely be assigned a new IP address, except in the particular case of a WPAN/WLAN switch where access points AP1-4 belong to the same IP subnet. It can be noted here that an IP subnet is defined as a portion of a network that shares a common address component. On TCP/IP networks, subnets are defined as all devices whose IP addresses have the same prefix.

The problems to be solved may therefore include one or more of the following:
1. sensing the presence of a different wireless network infrastructure (BT, IEEE 802.11, GPRS);
2. deciding when to perform the vertical handover;
3. reconfiguring the wireless hardware 22 so that the new wireless infrastructure (BT, IEEE 802.11, GPRS) is used;
4. registering with the new network (including AAA);
5. getting a new IP address (if necessary);
6. handling the routing of IP packets through the new access network (BT, IEEE 802.11, GPRS) and access point AP (AP1-4, BS1,2) through proper signaling at the network layer;
7. reconfiguring the wireless network interface so that the new standard is used to connect to the Internet and the new 1P address is used; and
8. Security.

The present invention focuses at least in part on reconfiguration of the wireless network driver of the client/mobile device MT (points 1, 2, 3 and 7, 8), basically below the network layer of the OSI protocol stack. Solutions to at least (4), (5) and (6) of the remaining points are being considered by the Internet Engineering Task Force (IETF) IP mobility protocols, e.g. mobile IP.

With regard to security (item 8 above), mobility of client devices MT increases security risks that are already intrinsically present in wireless access and Internet architecture. A secure solution should prevent against unauthorized access to the wireless network infrastructure and subsequently to the server pool 40, as well as avoiding all attacks that might result in denial of service. Security may be enforced at different layers, from the link layer to the application layer, with different implications on the systems architecture, overall performance and complexity. Security threats may include eavesdropping, redirection of traffic and man-in-the-middle relays.

With regard to connectivity, in order to perform vertical handovers in the mobile terminal MT, there must be a coordination of functions belonging to the data link layer (managing multiple wireless interfaces) and at the network layer (making sure the mobile terminal MT gets a new routable IP address and that packets are actually delivered to that address. Vertical handovers in accordance with the present invention are enabled by a form of Wireless Adaptation Layer (WAL) network driver, whose internal architecture is depicted with particular reference to FIGS. 2 and 3.

The network driver is a flexible network interface manager which supports multiple wireless standards and is therefore referred to as a Multi-standard Wireless Adaptation Layer (MWAL) 200. In this embodiment, the MWAL 200 runs only in the mobile terminal MT and may be seen by the operating system of the mobile terminal MT as an Ethernet interface that can be controlled by means of a socket interface from the application layer. MWAL 200 is a virtual network driver that can control and use other network drivers in a co-ordinated manner and handles the different link layers (GPRS, BT, IEEE802.11b). It exposes a single network interface to the routing entity, where diversity of network access technology remains hidden, and provides to the operating system of the mobile terminal MT and to applications a single interface (“wal0” in FIG. 3) between Layer 2 and Layer 3 where data, commands and events are exchanged. In this manner, the interface provides separate access to the data plane and control plane of the wireless driver. By means of this distinction, the MWAL control application in the user space, referred to as the WAL daemon (WALD) can manage connection set-up and security authorization through one driver (e.g. Bluetooth), while another driver is being used to exchange data (e.g. GPRS). While the MWAL 200 is used to coordinate operation of wireless transceivers during vertical handovers and to provide a single interface to upper routing entities in the mobile terminal MT, Layer-3 mobility issues may typically be addressed by Mobile Internet Protocol (MIP) and its variations, such as Hierarchical Mobile IP (EMIP).

Software modules X, Y can be dynamically loaded and unloaded in the MWAL 200 like plug-ins in order to interface the multi-standard wireless hardware 22 (which may be embodied in the form of a combination chipset) or to operate on IP packets that are forwarded by the MWAL interface.

MWAL Events

It is possible to register applications with the MWAL 200 to receive events when certain conditions occur. A Routing Manager can therefore be notified when a new wireless interface has become available, so that layer-3 mechanisms can be invoked (e.g. binding updates). In FIG. 3 this is implemented by way of example using the Linux/proc filesystem. In a Windows™ OS a suitable callback function can be registered instead.

WAL Daemon

The Wireless Adaptation Layer Daemon (WALD) is responsible for managing MWAL internal operation in such a way that applications only see a “wal0” network interface, regardless of the actual mapping of such interface to a specific wireless technology. WALD can also launch other user space daemons, such as PPPD, which is responsible for negotiating GPRS connections.

MWAL Functional Blocks

The WAL co-ordinator 206 inside MWAL handles both commands (possibly directed to different network drivers) and events (to be forwarded to registered entities in the upper layers). MWAL 200 controls other network drivers by means of dedicated modules, called Logical Link Control Translators (LLCT) 204. These modules are responsible for transmitting data frames and commands to (and for receiving data frames and events by) existing network drivers such as WLAN, Bluetooth and GPRS. At the same time, all LLCTs 204 can be controlled in the same way from the WAL co-ordinator 206.

If an application wants to have an indication of the current link quality on the wireless channel, it can issue a command on the wal0 interface. This command may be translated into a request for reading a Received Signal Strength Indicator (RSSI) in the case of Bluetooth or in a request for Signal-to-Noise Ratio (SNR) in case of IEEE802.11. The returned value is normalized into a technology independent metric by the LLCT 204 and eventually returned to the application.

Further to providing a single uniform interface to upper layers, the MWAL has the capability to load/unload packet processing modules, which perform operations on IP packets such as delaying TCP acknowledgement packets or caching TCP segments.

MWAL API

The MWAL exports two Application Programmers' Interfaces (API), one is a private API to be used by WALD and the other is a public one to be used by applications. The public API is defined in terms of commands that can be issued by applications and executed by the MWAL and events that are sent by the MWAL to relevant processes.

Private MWAL API (only used by WALD)
commands:
c1—select_MWAL_Data_Plane ({GPRS, BT, WLAN})
   actually switches the active interface to exchange data packets
c2—select_MWAL_Control_Plane ({GPRS, BT, WLAN})
   selects an interface to which commands must be sent (commands are ioctl calls under Linux)
c3—driver specific_commands
   ioctl( ) commands that existing drivers already understand
   events:
e1—all events already generated by existing drivers (sent to WALD)
   Public MWAL API (to be used by context-aware applications, details still to be defined)
   commands:
c4—get_link_quality
   technology independent link quality measurement
c5—registerListener
   registers an application that wants to receive MWAL events
c6—get type (name) of bearer
c7—get bandwidth (available/max)
c8—QoS support (probably not in phase 1) c9—range (for P2P apps)
c10—get/set security parameters (?)
c11—get power consumption
   events:
e2—handoverEvent (sent to layer 3)
   signals that a handover has been performed, so that the routing manager can update the tunnel configuration
e3—connectionEvent (sent to layer 3)
   signals that a connection has been established with the server for the first time, so that a tunnel can be set-up
e4—disconnectionEvent (sent to layer 3)
   signals that the connection should be terminated so the tunnel must be torn down

Link Outage Protection Module

Referring now also to FIG. 4, the effects of link disconnection of TCP may be considered. When a mobile terminal MT has an ongoing TCP/IP connection with a server 40, e.g. in the server pool on the Internet, it is necessary to ensure that it does not stall during vertical handovers. What may happen is that some in-fly TCP packets are lost during the execution of a vertical handover process. This behavior could be prevented if certain assumptions could be made on the capabilities of the network infrastructure, but this may not always be the case in some embodiments. The result of lost TCP segments is a high probability of TCP timeouts in the sender (which is usually a server 40 on the Internet). Whenever a TCP timeout is triggered, packet retransmissions occur according to an exponential back-off delay. Therefore a short break in link connection may result in TCP interruptions of seconds (as seen by the applications).

An optional WAL module X, Y can be loaded when it is important to ensure that an ongoing TCP/IP connection is not interrupted during the vertical handover procedure. This module, also referred to as link outage protection (LOP) module, monitors the flow of TCP/IP segments in both upstream and downstream directions. It freezes the TCP sender whenever the wireless link becomes unusable until a new link is available and the flow of TCP/IP segments can resume. This behavior prevents the TCP/IP connections from stalling and congestion control mechanisms from being unnecessarily invoked, with consequent TCP throughput reduction and packet retransmissions. A LOP module in the MWAL 200 of the mobile terminal MT prevents these undesirable effects and makes sure that the TCP stream is resumed as soon as the link connectivity is re-established. A necessary condition for LOP to work may be that TCP/IP packet headers are readable (i.e. not encrypted), which may create some security problems. Therefore LOP processing must be performed in the Mobile Terminal after packet decryption (when receiving) and before packet encryption (when transmitting).

Logical Link Control Translators 204

The lower layer driver modules for WPAN, WLAN or cellular systems (BT, IEEE 802.11, GPRS) are called Logical Link Control Translators (LLCT's) and are designated in group as 204 and individually as 204A, 204B and 204C respectively. The LLCT's 204 are responsible for encapsulating all the specifics of their associated radio technology for the transmission/reception of IP packets on the wireless link. For example, in the case of WPAN, the related Bluetooth WAL LLCT module 204A may include the upper layers of the Bluetooth BT protocol stack and its Personal Area Network (PAN) profile; the interface with the multi-standard wireless hardware 22 preferably being compliant with the Bluetooth Host Controller Interface (HCI). For a WLAN LLCT module 204B, the processing is limited to interfacing the multi-standard wireless hardware 22 and handling the transmission and reception of Ethernet frames.

All MWAL LLCT modules 204A,B,C perform the following functions (under control of WALD):
initialization of the lower layers of the baseband processor(s);
exchanging data frames as well as control messages with the multi-standard wireless hardware 22 according to the specific interface;
executing the establishment of connections when necessary;
managing the paging channel when available so that the mobile terminal MT can be woken up from idle mode, for example to receive an incoming call;
managing the low-power modes of the radio module when available (e.g. Bluetooth SNIFF mode);
performing security procedures related to accessing the wireless infrastructure
monitoring the wireless channel quality and making it available to a WAL coordinator 206 in a standard-independent way.

LLCT's 204 can be loaded simultaneously in the MWAL 200 when needed but only one can actually forward frames between the MWAL 200 and the multi-standard wireless hardware 22. In other words, LLCTs 204 have a data plane and a control plane. When multiple LLCTs 204 are loaded in the MWAL 200, only one can have an active data plane, while all of them can perform functions in the control plane such as discovering if a network infrastructure (WPAN 10, WLAN 12, cellular 14) is present or establishing connections before actually exchanging data.

WAL Coordinator 206

A WAL coordinator 206 loads or unloads a dynamic WAL module 202 and controls the overall behavior of the MWAL interface. Modules 202 can be unloaded to save memory in the mobile terminal MT. The WAL coordinator 206 receives control information 208 from all LLCTs 204 and informs the upper layers when a vertical handover needs to be performed.

Each packet received from the IP stack is classified in the WAL coordinator 206 by examining the header information of the upper layer protocols. Once classified, the packet to be transmitted is passed downstream to other MWAL modules X, Y, 204. The last module in the chain must always be an LLCT 204, which takes care of transmission of the IP packet on the physical medium (WPAN 10, WLAN 12, cellular 14). Examples of useful MWAL modules X, Y that can be used during the vertical handover are disclosed below.

MAC Spoofing Module

As the MWAL 200 appears to the operating system of the mobile terminal MT as a shared resources network interface such as an Ethernet interface, it is desirable that its MAC address does not change during a vertical handover. However, WPAN and WLAN cards may well have different MAC addresses. The MWAL 200 can take care of mapping the MAC address exported by the MWAL interface to the one that is used on the lower layers. This means that a MAC spoofing module in the MWAL 200 changes the MAC source address in outgoing Ethernet frames and the MAC destination address in incoming Ethernet frames. This module must also convert MAC addresses that are passed in the payloads of the Address Resolution Protocol (ARP) for IPv4 and neighbor discovery for IPv6.

Quality of Service module

A Quality of Service (QoS) module inside the MWAL 200 can be used to schedule the transmission of IP packets according to application requirements. In the simplest case, the QoS module can give priority to UDP packets over TCP packets based on the classification performed by the WAL coordinator 206.

Routing

Operations at the network layer include:
1) the mobile terminal MT getting a valid IP address when connecting to a network infrastructure;
2) the mobile terminal MT getting an IP address from a server 40, which address remains unchanged throughout the session so that applications do not need to be restarted after vertical handover;
3) maintaining a consistent mapping between the mobile terminal device IP address as seen by the applications (which must not change during vertical handover) and an IP care-of-address (CoA) which varies depending on the network infrastructure; and
4) maintaining the same IP addresses mapping at the server side (binding table)

IP tunneling is the basic mechanism to fulfill the first two above requirements. In the mobile terminal case, the mobile terminal MT and the server 40 are responsible for encapsulating and decapsulating packets in the IP tunnel as well as exchanging signaling to consistently and securely manage the tunnel configuration at initialization time and after a vertical handover. This is the traditional domain of Mobile IP.

The architecture of the present invention is open enough to accommodate future variations to routing strategy. Specifically, it is envisaged that Mobile IPv6 may be integrated when useable. As layer 3 mechanisms fall outside the scope of the current discussion, it suffices here to merely mention that an interface between the MWAL at layer 2 and the routing entities that manage mobility at layer 3 should preferably be standardized. In an aspect of this invention one possible such interface is proposed that is generic enough to be used in existing and future network mobility solutions and such an interface proposal has been described herein under M-WAL API. In the short term, an application in the mobile terminal, called Routing Manager (RM), is responsible for managing the IP configuration, based on the MWAL virtual network driver and an IP tunneling module in the OS kernel.

The routing manager RM in the mobile terminal MT is responsible for managing the four steps described at the beginning of the section. Based on the interaction with the remote server 40, the routing manager RM configures the MWAL interface and the IP tunnel configuration in the mobile terminal. This process can be performed in the user space.

It may be useful here to provide further details of the configuration of IP tunnels. An IP tunnel is set-up between the mobile terminal MT and the remote Tunnel Endpoint, so the resulting data packets are encapsulated as shown in FIG. 5. It can be noticed that a 4-byte GRE header has been added to allow NAT/firewall traversal. Much network equipment supports GRE.

The TCP header overhead varies depending on the end-to-end negotiated parameters: among them, the most relevant for the mobile terminal MT are the SACK and timestamp options, that ease the problem of packets lost in the wireless link. SACK and timestamp options add 12 to 24 bytes to the 20-byte TCP header.

MWAL State Diagram

Class diagrams of the MWAL 200 are depicted in FIGS. 6 and 7 using standard Unified Modeling Language (UML) notation. The main classes, their methods as well as class relationships are shown.

The MobileNodeApplication, ClientRouting and WALD classes all use the MWAL class, which represents the generalized network interface. As explained earlier, the MobileNodeApplication is not aware of the operations occurring in the MWAL. WALD controls the connection establishment/handover processes, while ClientRouting handles layer-3 operations like getting the Care of Address CoA and maintaining the IP tunnel. It should be emphasized that there is no explicit relationship between the WALD and the ClientRouting classes, which only communicate via the MWAL 200: this is important because no dependency on the specific routing mechanism is introduced. In other words, it will be possible to use a MIPv6 layer-3 solution in the future and the present invention encompasses this option.

While WALD and ClientRouting classes use a private MWAL interface, other applications, such as context-aware ones, can use a public MWAL interface mainly to retrieve wireless-related information. This does not mean that applications should be changed to use the MWAL 200, but simply that MWAL 200 enables development and implementation of new applications that exploit the information that it exports.

The MWAL class diagrams are an aggregation of several MWALModules. The WALModule interface is specialized by the LLCT Interface, which in turn is realized by BTLLCT 204A, WLANLLCT 204B and GPRSLLCT 204C. All Logical Link Control classes use the corresponding existing network driver.

Initial Access to the Server 40

This section describes the procedure by means of which the mobile terminal MT initially accesses the application server 40 through a wireless network infrastructure connected to the Internet, or other IP based network as the case may be. The sequence diagram of FIG. 8 will be used as a reference, in which the objects involved in the interactions are shown at the top.

The WALD periodically checks if a wireless network infrastructure (for example one of WLAN, Bluetooth or GPRS) is present and, based on user's preferences may decide to connect to one of them. Once the initial command is sent by the WALD to the MWAL 200 (step 1), it is forwarded to the Bluetooth LLCT 204A (step 2), where the inquiry, paging and SDP operations are performed on the BT driver (3), according to the LAN access profile or (even better) the PAN profile. If a suitable network access point AP1,2 that provides Internet access can be found, an indication is sent back to the WALD (4). This entity may then decide that a connection with the Bluetooth bearer should be established; therefore the corresponding command is issued (5). This command to connect is forwarded to the Bluetooth LLCT (6), which starts the network access procedures specified by the Bluetooth profile being used (7).

This access phase may or may not include authentication and link key generation. Once the process is completed and a connection has been established between the mobile terminal MT and a network access point AP1,2, a “bearer authenticated” event is sent to the WALD (8), which indicates that the link is finally ready to be used to exchange data.

The WALD then activates the interface by sending the select command (9). An event is then generated by the MWAL to the Routing Manager RM (step 10), which triggers the activation of layer-3 procedures like getting a valid IP Care-of-Address (getCOA, step 11). The event is generated by the MWAL 200 to avoid direct communication between the routing entity and the WALD. In this way future routing mechanisms can be accommodated, for example MIPv6. Once a routable IP address has been obtained using whatever mechanism (DHCP, PPP or IPv6 auto-configuration in the future), it is assigned to the MWAL interface (12). From this point on, data can be exchanged between the mobile terminal MT and the server 40.

The routing manager RM sends a request to the application server 40 to get an application IP address (steps 13 to 16), using the MWAL network interface and the Bluetooth connection that has been previously created. The request is done using Mobile IP messages or proprietary routing management protocols. Upon success, an application IP address (also referred to as “Home Address” is assigned to the client, which will remain unchanged throughout the session. The tunnel endpoint is set-up on the server (18) and the IP address is communicated back to the client (19 to 22) in a Web page that the routing manager RM is responsible for parsing. Once this process is complete, the IP tunnel is set up on the mobile terminal MT (23) to associate the client application IP address with its current CoA (also called IPbearer in FIG. 8).

If all the steps above complete successfully, there will be an IP tunnel set-up between the MN and the server, where the TCP payload is encrypted, the reserved SSL port 243 will be used and the TCP/IP headers are in clear to allow LOP operation. Data can now flow between the mobile terminal MT and the application server (24 to 28), using the tunnel that has been configured. In case of failures, the mobile terminal may try to use another available interface or prompt the user that the remote server 40 is unavailable.

Execution of a Vertical Handover Inside the MWAL 200

When a vertical handover has to be executed, the sequences of operations depicted in FIGS. 9 and/or 10 are performed inside the MWAL 200.

The example that has been used for FIG. 9 refers to a mobile terminal MT using GPRS entering a building with a Bluetooth BT network infrastructure, i.e. WPAN 10. The WAL coordinator may (periodically) load the LLCT 204 to check for the presence of an access point AP or a base station BS.

When the Bluetooth (BT) LLCT 204A is loaded and its associated checkNetworkInfrastructure( ) method is invoked, the Bluetooth inquiry procedure is executed. If a Bluetooth network access point AP1-2 is found for which the user has access privileges, a connection is created and a positive response is returned to the WAL coordinator 206. At this point, the GPRS data flow is disabled in favor of the Bluetooth LLCT 204A and the GPRS LLCT 204C is finally unloaded from the host memory.

When there is an ongoing TCP session between the mobile terminal MT and a remote host on the Internet that should not be interrupted during a vertical handover, the optional link outage protection module LOP should be loaded and activated. When the process has completed, the WAL coordinator 206 unloads the LOP module.

Similarly, when there are multiple connections involving the mobile terminal MT where the MWAL 200 is running, the optional QoS module can be loaded to prioritize traffic according to application requirements.

Referring now for the moment in particular to the sequence diagram of FIG. 10 depicting a vertical handover, when the mobile terminal MT has an active connection with server 40 through one wireless infrastructure BT, IEEE802.11b, GPRS) and the quality of the link decreases, a handover from the current access point or even access technology to another may become necessary, e.g. to a better supported access point and/or technology. Alternatively, the mobile terminal MT may periodically check for the availability of other wireless networks and decide to switch to one of them according to user-defined criteria. If another access point AP1-4 is available to connect to, which uses the same technology, the mobile terminal MT must check if the new access point AP1-4 belongs to the same IP subnet and, if not, get a new CoA address and reconfigure its IP tunnel to maintain the connection with the remote application server 40. If no access points AP1-4 are available, the mobile terminal MT may want to try alternative wireless infrastructures (vertical handover). This latter process is detailed in FIG. 10 for the case of a WLAN/GPRS switch.

While the mobile terminal MT is exchanging data using the WLAN infrastructure (steps 1 to 3), an event is generated by the MWAL 200 to the WALD (step 4) that indicates that the link quality is decreasing. The WALD activates the LOP module (step 5) to start buffering TCP segments and a search for alternative available wireless networks is triggered (6) in the MWAL 200. This command is sent to both the WLAN LLCT (7) and GPRS LLCT (8). Bluetooth is not shown in this specific but non-limiting example, so as to limit the complexity of the Figure. In the meantime, data continues to flow using the previous WLAN access point (9 to 11), assuming the link is still usable.

Once a new/alternative infrastructure is detected (12) as available, the WALD decides to establish a GPRS connection (13). The MWAL 200 initiates access procedures (14), which involve link authentication. Once the authentication has completed (15) and the link is usable, an event is sent back to WALD (15), which finally sends the select command (16), which causes data packets to be sent to the new GPRS link. A handover event is generated towards the routing manager RM by the MWAL interface (17) to signal that layer-3 procedures should be triggered, such as getting a new valid Care-of-Address CoA (18). Once the new IP address has been obtained, it is assigned to the MWAL (19). At this point, the IP tunnel is reconfigured (20) in the mobile terminal MT with the new mapping {IP_client, IP_bearer2}. In order to update the tunnel configuration at the remote side, a dedicated binding update message will be sent by the Routing Manager RM to the authentication server 40. The server 40 will communicate the new configuration to the Tunnel Endpoint (24) so that data packets will be encapsulated with the new outer destination IP address (the new client CoA). After the tunnel configuration has been updated, a confirmation page is sent back to the client (25 to 27). This completes the vertical handover process.

It should be mentioned that link quality degradation is not the only reason to trigger the vertical handover process. In fact, WALD may decide to start the handover process based on criteria like cost, available bandwidth and power considerations. The user can indicate his preferences using a dedicated mobility configuration tool.

Interface Between the WAL and the Upper Layers

The application programmers' interface for networking used most widely currently is the socket interface. This is a set of functions originally developed by Berkeley University to establish TCP/IP and UDP/IP connections between applications on the Internet, for which the following reference may be useful:
(7) J. Tourrilles, “Wireless Extensions” at: http://www.hpl.hp.com/personal/Jean Tourrilhes/Linux/Tools.html

A local socket can also be created to communicate locally, for example between two applications that run on the same host or between an application and a network driver.

The MWAL interface falls in the latter socket category since it uses two raw sockets for communicating with the application space in the host, as shown in FIG. 12. The WAL coordinator 206 is responsible for receiving commands from applications and sending events back. An application in the user space 210 can launch a separate thread to process asynchronous MWAL events, which are passed in a dedicated socket. The application in the user space 210 creates both command and event sockets 212, 214 and passes a reference to the event socket down to the driver using a specific “ioctl” socket command. The data structure used to exchange information between the MWAL and the application space is the standard “ifreq” data structure, which is passed by reference between the driver and the application using the “ioctl” command, as discussed in (7) J. Tourrilles, “Wireless Extensions”.

New commands and parameters may be defined for:
loading and unloading MWAL modules X, Y;
setting module parameters;
passing the reference to the event socket 214 upon initialization;
handling the management of link layer connections;
handling link layer security;
reporting link quality indications; and
managing the low-power modes and the paging channel (if any).

Security

Security can be applied at different layers of the protocol stack, from the link layer up to the application layer. Both the wireless link between the mobile terminal MT and the access network AP, BS and the end-to-end connection with the server pool 40 need to be secured. Several options may be considered to enforce security, including VPN based on PPTP/GRE or IPSEC/ESP, TLS/SSL, IEEE802.1x in the access points with TLS/EAP higher layer authentication and key generation. Each such option has its own advantages and disadvantages.

Since the emphasis may primarily be on the continued client operation during vertical handovers, it may prove desirable to use TLS/SSL between the client MT and the server 40, with GRE tunnels to ease firewall/NAT traversal and optional link-layer encryption in the wireless hop (between the mobile terminal MT and the access point AP). This solution allows the TCP/IP header to be received unencrypted in the MWAL interface of the mobile terminal MT so that the LOP function can be implemented. Alternatively, link encryption may be used at the cost of a slightly higher resource consumption in the mobile terminal MT.

Mutual authentication between the mobile terminal MT and the remote server 40 can be accomplished by means of SSL certificates, which can be issued to customers by the entity that manages the service. One disadvantage of this solution is that SSL-enabled applications need to be used. Currently Windows CE browsers and email clients support SSL already, therefore this is not considered to be a major obstacle to the mobile terminal acceptance.

If distributing security certificates to clients is not desirable, a username/password mechanism can be used as detailed herein under “Server-side Processing”, e.g. which exploits standard security mechanisms of the Web server that manages client authentication. As far as securing the access of mobile terminals MT to the wireless infrastructure is concerned the following considerations can be made:
For the GPRS case, SIM based security is the standard;
For Bluetooth, a bonding procedure with the network of access points AP 1,2 is necessary the first time they are accessed. Since it is preferable not to bother the users with pairing procedure for each access point AP1,2 in the infrastructure, the concept of ‘group keys’ can be used. This is a new feature that has been introduced by the Security Experts Group in the BT Special Interests Group (SIG), which does not require changes in the current BT1.1 HW/FW. Whenever a handover happens, no re-authentication is needed. It is useful to mention here that the details about using group keys in the Bluetooth infrastructure are being included in the BT Access Point Roaming (APR) specification, due for publication shortly.
For WLAN, traditional WEP encryption can be used, although this may prove to be less than an ideal solution. Access to the infrastructure can be controlled by connecting the access points AP3,4 to a RADIUS server 300, 302 and allowing only frames with registered MAC addresses to be bridged. This may not be considered the most secure procedure either, since it may prove possible to spoof MAC addresses. An EEE802.1x architecture might solve the problem but this kind of infrastructure is not essential to the present invention.

The point of connection of the corporate network to the Internet (ingress router) should always be protected by one or more firewalls and the mobile terminal should take consequent limitations into account without requiring any special policy in the firewall configuration.

In the corporate infrastructure, a RADIUS server 300, 302 may be used to control access of mobile terminals MT. A DHCP infrastructure may also be deployed, so that mobile terminals MT can get a leased IP address. As far as further security is concerned, one or more of the following mechanisms may be incorporated:
applications may be based on a secure data transfer such as Secure Socket Layer (SSL);
location updates may also be protected using a secure data transfer such as SSL, possibly through a proprietary mechanism;
access to the wireless network may be controlled through standard mechanisms providing challenges for authentication and/or verification (for example, access points AP connected to a RADIUS server and GPRS SIM based security);
a firewall may be installed in the MT to prevent unauthorized access from the external network,
firewalls may be used whenever the access networks need to connect to the Internet; and
since access procedures are usually time consuming because of initial authentication, MWAL can perform these tasks on one interface while another one is being used. This can shorten the Handover process because access procedures and data exchange are being pipelined.

In one aspect the present invention extends a basic WAL framework to allow a client device/mobile terminal to perform vertical handovers, i.e. to switch between one wireless access standard and a different one in such a way that existing data connections are not stalled or interrupted and no user intervention is required. It can thus be seen that the present invention provides an efficient arrangement to enable client devices to switch from one wireless access standard to another, preferably depending on the sensed wireless network infrastructure.

While the present invention has been particularly shown and described with respect to a preferred embodiment, it will be understood by those skilled in the art that changes in form and detail may be made without departing from the scope and spirit of the invention. For example, it will be appreciated that use herein of the term Internet encompasses connection to equivalent arrangements such as to other Internet Protocol (IP) based systems. In addition, the client device has been disclosed embodied in the form of a mobile terminal to reflect portability by a user or at least the need to be able to switch between different wireless communications standards, e.g. in the event that available network infrastructure changes. Such a mobile terminal may comprise for example a Personal Digital Assistant (PDA), a lap-top computer or a mobile communications device, but it will be appreciated that the client device may in fact be stationary either temporarily or substantially permanently. It may also be the case that, with respect to one, more or all access networks, the client device is stationary and it is the or each surrounding network infrastructure which is moving, in which case mobility of the client device may be considered to express relative movement between that device and its access network or networks.

Glossary:

| | |
|---|---|
| 3G | Third generation cellular systems |
| AAA | Authentication, Authorization and Accounting |
| ARP | Address Resolution Protocol |
| GPRS | Generalized Packet Radio System |
| HCI | Host Controller Interface |
| IETF | Internet Engineering Task Force |
| IP | Internet Protocol |
| LAN | Local Area Network |
| LLCT | Logical Link Control Translator |
| LOP | Link Outage Protection |
| MAC | Medium Access Control |
| MT | Mobile Terminal |
| PAN | Personal Area Network |
| TCP | Transmission Control Protocol |
| UDP | User Datagram Protocol |
| WAL | Wireless Adaptation Layer |
| WLAN | Wireless Local Area Network |
| WPAN | Wireless Personal Area Network |

1. A client device for an Internet Protocol (IP) based communications arrangement, said client device including multi-standard hardware adapted to support wireless operation of said client device in accordance with a plurality of Internet Protocol compatible wireless communications standards, operation of said multi-standard hardware being controlled by a network driver that includes a software architecture having a wireless adaptation layer, wherein the software architecture is arranged in use to enable said client device to perform vertical handovers between said wireless communications standards when information is being transmitted to said client device from a sender via a wireless link, said software architecture including a software module for optionally freezing the sender.

2. A client device according to claim 1, wherein the software module is adapted to freeze the sender if the wireless link becomes unavailable.

3. A client device, according to claim 1, wherein the software module is adapted for monitoring the flow of Transport Control and/or Internet Protocols (TCP/IP) segments in both upstream and downstream directions, said module preferably freezing a Transport Control Protocol (TCP) sender if a wireless link becomes unusable, further preferably freezing said sender at least until a new link becomes available.

4. A client device, according to claim 1, wherein said vertical handovers are seamless.

5. A client device, according to claim 1, wherein said wireless adaptation layer is adapted to allow network based applications to be run transparently on said client device during said vertical handovers.

6. A client device, according to claim 1, wherein said client device determines which wireless access networks are available and said vertical handovers are performed in dependence on the infrastructure of the or each said available wireless access network.

7. A client device, according to claim 1, wherein said device comprises a user portable terminal.

8. A client device, according to claim 1, wherein a said Internet Protocol compatible wireless communications standard comprises one of the Generalized Packet Radio System (GPRS), IEEE 802.11 and Bluetooth standards.

9. A software product suitable for implementing a wireless adaptation layer of a network driver in a client device according to any preceding claim, said software product including code for providing a uniform interface to an Internet Protocol layer of a protocol stack of said client device for at least one of:
a) transmitting Internet Protocol packets;
b) monitoring radio link quality;
c) controlling radio link quality;
d) paging further devices;
e) handing over said client device between different access points or base stations of a network or between networks, and
f) optionally freezing a sender.

10. A software product according to claim 9, wherein said wireless adaptation layer interface provides to an operating system of said client device and to applications a single interface between Layer 2 and Layer 3 of an OSI protocol stack, through which interface one or more of data, commands and events are exchanged.

11. A software product according to claim 10, further including a wireless adaptation layer coordinator for controlling the overall operation of said wireless adaptation layer interface and having code for at least one of:
a) determining and controlling the loading and unloading of software modules;
b) code for arranging a said vertical handover; and
c) code for receiving commands from applications and sending back events.

12. A software product according to claim 11, wherein said wireless adaptation layer interface provides separate access to a data plane and to a control plane of said network driver, so as to enable a control application of said wireless adaptation layer to manage a connection through one said wireless communications standard while another said wireless communications standard is used to exchange data.

13. A software product, according to claim 10, wherein said wireless adaptation layer interface appears to an operating system of said client device as a shared resource network interface that is controllable by means of a socket interface from an application layer.

14. A software product, according to claim 9, wherein software modules are dynamically loaded and unloaded into and out of the wireless adaptation layer, a said module including code for interfacing said wireless hardware to a said wireless communications standard or to operate on Internet Protocol packets that are forwarded by the wireless adaptation layer.

15. A software product, according to claim 9, including a lower layer driver module having code for encapsulating features specific to a particular said wireless communications standard for transmitting and/or receiving Internet Protocol packets on a wireless link between said client device and a further client device or a network.

16. A software product according to claim 15, a said lower layer module including code for at least one of the following:
a) initialization of the lower layers of a baseband processor;
b) exchanging data frames and/or control messages with said multi-standard hardware module;
c) managing the establishment of connections;
d) managing a paging channel such that said client device is woken from an idle mode;
e) managing a low power mode of said client device;
f) monitoring the quality of link in a wireless connection of said client device.

17. A software product, according to claim 15, wherein a said lower layer module comprises a data pane and a control plane, a said data plane including code for forwarding frames between said wireless adaptation layer and said hardware module and a said control plane including code for at least one of discovering if a network access infrastructure is present and establishing connections before exchanging data.

18. A software product, according to claim 13, further including a software module having code for monitoring the flow of Transport Control and/or Internet Protocols (TCP/IP) segments in both upstream and downstream directions, said module preferably including code for freezing a Transport Control Protocol (TCP) sender if a wireless link becomes unusable, further preferably freezing said sender at least until a new link becomes available.

19. A software product, according to claim 13, including a module having code for ensuring that a Medium Access Control (MAC) address of said wireless adaptation layer does not change during a said vertical handover.

20. A software product, according to claim 13, including a module having code for monitoring quality of service and, if multiple wireless connections are in place involving said client device, preferably also having code for prioritizing traffic according to the requirements of a currently running application.

21. A method of supporting wireless operation of a client device, the method including configuring multi-standard hardware of said client device to perform vertical handovers of said client device under the control of a wireless adaptation layer of a network driver between a plurality of Internet Protocol compatible wireless communications standards when information is being sent to the client device from a sender via a wireless link, the method comprising optionally freezing the sender if the wireless link becomes unavailable.

22. An Internet Protocol based communications system adapted to provide a connection with a client device through one of a plurality of wireless communications standards, a said client device preferably comprising a mobile terminal and including multi-standard hardware adapted to support wireless operation of said client device in accordance with a plurality of said wireless communications standards, operation in or changes between said standards being controlled by a predetermined software architecture that includes a wireless adaptation layer (WAL) arranged in use to enable said client device to perform vertical handovers between said wireless communications standards, wherein, when information is being transmitted to said client device from a sender via a wireless link, said software architecture includes a software module for optionally freezing the sender.
